(19) United States
(12) Patent Application Publication
(10) Pub. No.: US 2017/0147984 A1
(43) Pub. Date: May 25, 2017

(54) SYSTEM AND METHOD FOR SOURCING AND MATCHING A CANDIDATE TO JOBS

(71) Applicants: Adam D. Zoia, New York, NY (US); Richard Joffe, Palo Alto, CA (US); Oliver Brdiczka, San Jose, CA (US); Sushant Tripathy, Fremont, CA (US)

(72) Inventors: Adam D. Zoia, New York, NY (US); Richard Joffe, Palo Alto, CA (US); Oliver Brdiczka, San Jose, CA (US); Sushant Tripathy, Fremont, CA (US)

(73) Assignee: Stella.Ai, Inc., New York, NY (US)

(21) Appl. No.: 15/426,738

(22) Filed: Feb. 7, 2017

Related U.S. Application Data
(60) Provisional application No. 62/294,287, filed on Feb. 11, 2016.

(51) Int. Cl. G06Q 10/10; G06F 17/30

(52) U.S. Cl. CPC G06Q 10/1053; G06F 17/30867

(57) ABSTRACT

An improved system and method for sourcing and matching candidates to jobs is provided. In an embodiment, a user client may receive a notification having a link to an online application that includes information identifying a job for which a candidate was rejected. The user client may send a request to a job server to run an online application to search for job matches to the job profile for which the candidate was rejected, and a search may also be made for job matches to the candidate profile. A combined list of job matches to the candidate profile and job matches to the job profile for which the candidate was rejected may be ranked. A short list of ranked job matches may be served to a user client which may send a request to a company server to apply for a job on the short list.

### FIELD OF THE INVENTION

The invention relates generally to computer systems, and more particularly to an improved system and method for sourcing and matching a candidate to jobs.

### CROSS-REFERENCE TO RELATED APPLICATIONS

This application claims the benefit of U.S. Provisional Application No. 62/294,287, filed Feb. 11, 2016.

### BACKGROUND OF THE INVENTION

Conventional recruiting processes are very labor intensive and expensive. Recruiters frequently identify, locate, and source candidates for a job through manual searches online and in social networks. Corporate recruiters process candidate application information using commercially available applicant tracking systems. Typically, the applicant tracking systems for large corporations are internally hosted for use by their human resources department. Small companies may subscribe to applicant tracking services externally hosted by a third party. These commercially available applicant tracking systems support recruiting in capturing candidate applications to open jobs and tracking the applicant process. In addition to collecting resume information with work history and personally identifiable information, these systems collect various company evaluations of the candidate at various stages of the application process, including interview evaluations, reference feedback, offer negotiations, hiring information, and so forth.

Although these systems provide essential support for human resource departments to track the applicant process, these systems fail, however, to capture candidate feedback on company employees, company culture, organization and work environment, perhaps with the exception of company surveys of candidates who reject job offers. These internal or externally hosted systems also fail to capture a candidate's concurrent applications at other companies, application history, and candidate job interest history. Moreover, these systems fail to share candidate evaluations that may be captured by different companies. Recruiters can improve their evaluation of candidates using this information and may more efficiently source appropriate candidates.

Even if candidate evaluations were shared, existing technological processes and systems poorly match candidates to jobs because such systems are unable to reconcile variant company job level categorizations, dissonant job requirements and descriptions for comparable jobs, differing corporate soft skills, varying corporate cultural biases and inconsistent eligibility requirements. Such inadequate technological processes result in mismatches between candidates and jobs that lead to unexpected attrition rates and staffing costs.

What is needed are improved technological processes and a system that can discover the best candidates that are good fits for a particular job, and can assist candidates in managing their employment opportunities. Such technological processes and system should allow candidates to find jobs they want in a suitable company.

### SUMMARY OF THE INVENTION

Briefly, a system and method for sourcing and matching candidates to jobs is presented. In various embodiments, a user client may be operably connected to a company server and a job server. The user client may include a messaging application having functionality for receiving a notification having a link to an online application that includes information identifying a job for which a candidate was rejected, and the user client may include a personal recruiting application having functionality for sending a request, that includes the information identifying the job for which the candidate was rejected, to run an online application. The user client may communicate to a job server through a network and receive from the job server a short list of jobs matched by leveraging the job profile of the job for which the candidate was rejected. And the user client may send a request through a network to an online recruiting application on a company server to apply for a job on the short list of jobs matched.

In various embodiments, the job server may support services for matching candidates and jobs by leveraging information about one or more jobs for which a candidate was rejected. To do so, a personal recruiter application executing as an online application on the job server may include functionality for interacting with the personal recruiting application executing on the user client, functionality for receiving candidate information from the personal recruiting application, and functionality for sending a candidate job list to the personal recruiting application for display on the user client. The personal recruiter application may be operably connected to a job matching engine with functionality to match a candidate profile to job profiles by leveraging information about a job for which the candidate was rejected and with functionality to match a job profile of a job for which the candidate was rejected to job profiles. The job matching engine may be operably coupled to a ranking engine with functionality in an embodiment for receiving a request to rank a list of matching jobs scored by the job matching engine, functionality to combine rankings of matching jobs, and functionality to generate a short list of ranked matching jobs for the candidate.

In an embodiment, a request to run an online application may be received by the job server that includes information identifying a job for which a candidate was rejected. Requests for information to create a candidate profile may be sent, and a candidate profile may be generated by applying the responses to the requests for information to create a candidate profile. A search may be made for job matches to the job profile for which the candidate was rejected, and a search may be made for job matches to the candidate profile. A ranked list of job matches to the candidate profile and job matches to the job profile for which the candidate was rejected may be combined. And, a short list of ranked job matches may be served to a user client.

Advantageously, the system and method for sourcing and matching candidates to jobs may leverage information about a job for which the candidate was rejected that is indicative of the candidate's employment objectives and interests including the type of job and type of company. Conveniently, the system and method may automatically allow candidates to discover relevant jobs they want in a suitable company. Furthermore, the system and method may easily support submission of a candidate's application to relevant jobs they want in a suitable company.

Other advantages will become apparent from the following detailed description when taken in conjunction with the drawings, in which:

### BRIEF DESCRIPTION OF THE DRAWINGS

FIG. 1 is a block diagram generally representing a computer system as an illustrative example in an embodiment;

FIG. 2 is a block diagram generally representing an architecture of system components for matching a candidate to jobs utilizing job rejection information, as an illustrative example in an embodiment;

FIG. 3 is a flowchart generally representing the steps undertaken in an embodiment for searching for job matches for a candidate using the job profile for which the candidate was rejected;

FIG. 4 is a flowchart generally representing the steps undertaken in an embodiment on a client for searching for job matches for a candidate using the job profile for which the candidate was rejected;

FIG. 5 is a flowchart generally representing the steps undertaken in an embodiment on a server for searching for job matches for a candidate using the job profile for which the candidate was rejected and the candidate profile;

FIG. 6 is a flowchart generally representing the steps undertaken in an embodiment for matching a job profile to a job profile; and

FIG. 7 is a flowchart generally representing the steps undertaken in an embodiment for matching a candidate profile to a job profile.

### DETAILED DESCRIPTION

### Exemplary Operating Environment

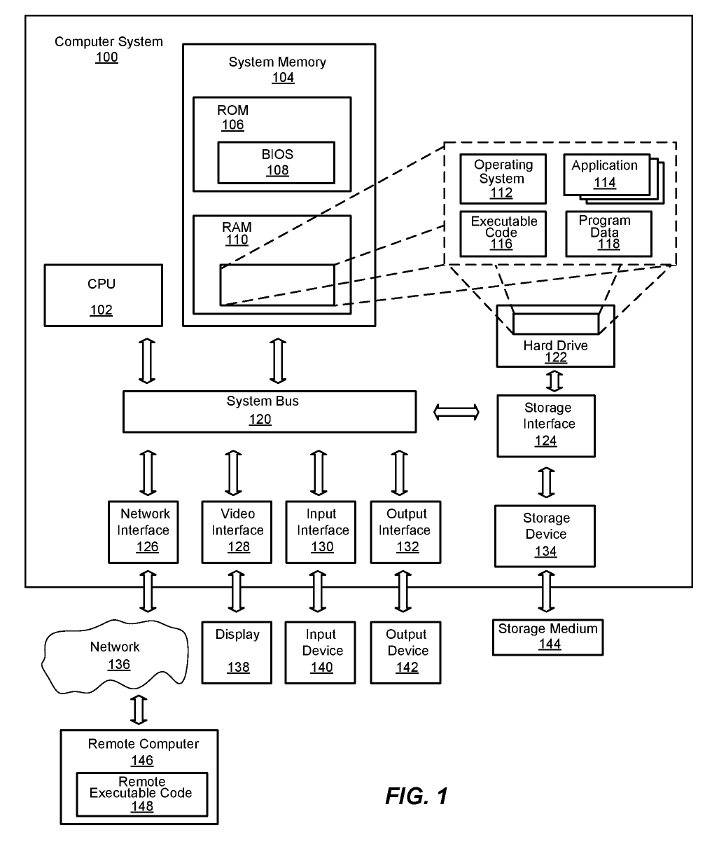

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be a solid-state drive that reads from or writes to non-removable, nonvolatile solid-state storage. Alternatively, storage device 134 may be a solid-state drive, an optical disk drive or a magnetic disk drive that reads from or writes to a removable, a nonvolatile storage medium 144 such as solid-state storage, an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

Those skilled in the art will appreciate that the computer system 100 may also be implemented within a system-on-a-chip architecture including memory, external interfaces and an operating system.

### Sourcing and Matching a Candidate to Jobs

A system and method is disclosed in various embodiments that are generally directed to sourcing and matching a candidate to jobs. More particularly, the system and method disclosed enables sourcing of a rejected candidate into a common candidate pool for matching to a repository of jobs aggregated from many companies. As will be seen, the system and method may match candidates and jobs by leveraging information about one or more jobs for which a candidate was rejected, and thereby more accurately surface job matches that fit the candidate's employment interests in the type of job and type of company desired. Furthermore, the system and method may support convenient submission of a candidate's application to relevant jobs they want in a suitable company. As will be understood, the various block diagrams, flow charts and scenarios described herein are only examples, and there are many other scenarios to which the system and method disclosed will apply.

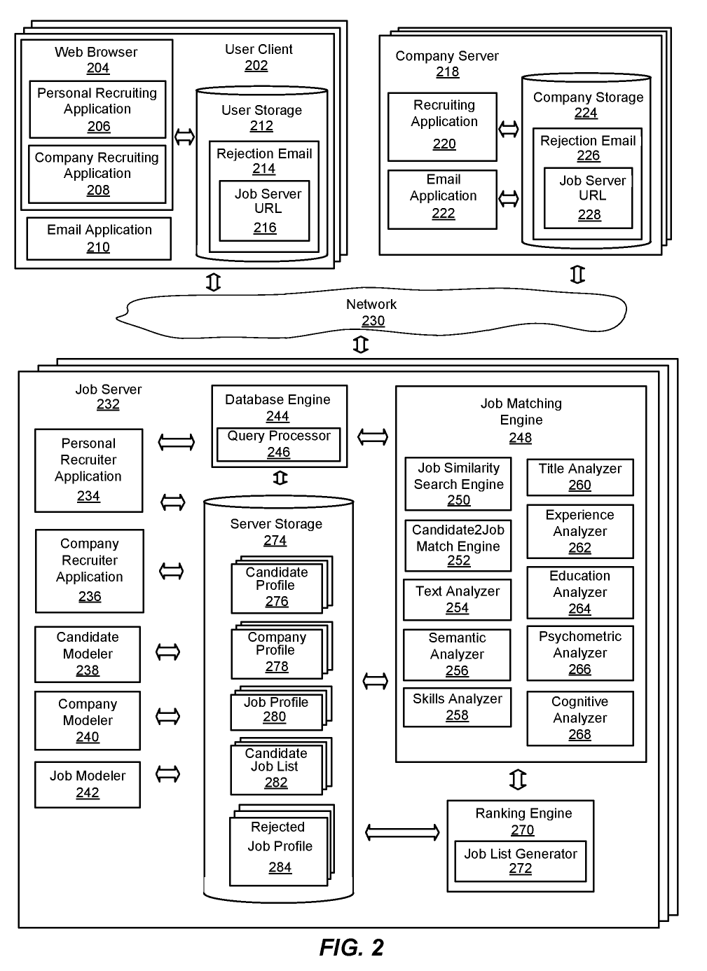

Turning to FIG. 2 of the drawings, there is shown a block diagram generally representing an architecture of system components in an embodiment for matching a candidate to jobs utilizing job rejection information as an illustrative example. Those skilled in the art will appreciate that the functionality implemented within the blocks illustrated in the diagram may be implemented as separate components or the functionality of several or all of the blocks may be implemented within a single component. For example, the functionality for the personal recruiting application 206 on the user client 202 may be implemented as a separate component from the web browser 204, which may be the case for a mobile device such as a smartphone. Note that in an embodiment on a mobile device, the functionality of the personal recruiting application 206 may be implemented both within the web browser 204 as shown and as a separate component so that a mobile device user may use either the web browser 204 with the functionality of the personal recruiting application 206 included or the personal recruiting application 206 as a separate application component. As another example, the functionality of the text analyzer 254, the semantic analyzer 256 and the title analyzer 260 may be implemented in an alternate embodiment within a single component. Moreover, those skilled in the art will appreciate that the functionality implemented within the blocks illustrated in the diagram may be executed on a single computer or distributed across a plurality of computers for execution. Furthermore, those skilled in the art may also appreciate that the functionality of the present invention may also be implemented using a thin client whereby the functionality of the web browser 204, the personal recruiting application 206, and the email application 210 may be implemented on the job server 232. In such an embodiment, the user client 202 merely acts as an interface for a user to interact with the job server 232.

In various embodiments, a user client 202 may communicate with one or more job servers 232 through a network 230. The user client 202 may be a computer such as computer system 100 of FIG. 1 or another computing device including a mobile device such as a mobile phone. The network 230 may be any type of network such as the Internet, a cellular network, a local area network (LAN), a wide area network (WAN), or other type of network. A web browser 204 may execute on the user client 202 and may include functionality for receiving a request to perform an operation which may be input by a user and functionality for sending the request to a server to perform the operation. The web browser 204 may be operably coupled to an personal recruiting application 206 having functionality for receiving requests to perform an operation for the personal recruiting application 206 and functionality for sending the requests to the job server 232 to perform the requested operation for the personal recruiting application 206. The web browser 204 may also be operably coupled to a company recruiting application 208 having functionality for receiving requests to perform an operation for the company recruiting application 208 and functionality for sending the requests to the company server 218 to perform the requested operation for the company recruiting application 208.

Other applications may also execute on the user client 202 in various embodiments. For example, in embodiments where the user client 202 may be a computing device such as a mobile phone, a personal recruiting application 206 may execute on the mobile phone as a separate component from a web browser 204. The personal recruiting application 206 in this embodiment may have functionality for receiving requests to perform an operation for the personal recruiting application 206 and functionality for sending the requests to the job server 232 to perform the requested operation for the personal recruiting application 206.

Moreover, an email application 210 may execute on the user client 202 that may receive emails updating the user on the status of job applications in various embodiments. Other messaging applications may also execute on the user client 202 that likewise serve to receive updates about job applications in an embodiment. Such messaging applications may be any type of messaging application including an instant messaging application, a text messaging application such as Simple Message Service (SMS), a chat messaging application, and so forth.

The web browser 204 may also be operably coupled to user storage 212 that stores email messages such as rejection email message 214 that may include a selectable link such as job server URL (Uniform Resource Locator) 216 to send a request to the job server 232 to serve the landing page for the personal recruiting application 206. In addition to including a selectable link, the rejection email message 214 may embed information about the job for which the candidate was rejected including a job identifier, a job title, a company name, or a job location, and so forth.

In general, the web browser 204, the personal recruiting application 206, the company recruiting application 208, and the email application 210 may be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system. Alternatively, these components may also be implemented on a general purpose computing system or device as interpreted or executable software code such as a kernel component, an application program, a script, a linked library, an object with methods, and so forth.

The company server 218 may communicate with one or more user clients 202 through network 230 and may also communicate with one or more job servers 232 through network 230 in various embodiments. The company server 218 may be a computer such as computer system 100 of FIG. 1 or another computing device including a mobile device. A recruiting application 220 may execute on the company server 218 and may include functionality for interacting with candidates applying for a job, functionality for collecting candidate information from candidates applying for a job, functionality for tracking the application process, and functionality for communicating a candidate's status in the application process. An email application 222 may execute on the company server 218 that may send emails updating the user on the status of job applications in various embodiments. Other messaging applications may also execute on the company server 218 that likewise serve to send notifications about the status of job applications in an embodiment. Such messaging applications may be any type of messaging application including an instant messaging application, a text messaging application such as Simple Message Service (SMS), a chat messaging application, and so forth.

The email application 222 may be operably coupled to company storage 224 that stores email messages such as rejection email message 226 that may include a selectable link such as job server URL (Uniform Resource Locator) 228 to send a request to the job server 232 to serve the landing page for the personal recruiting application 206. In addition to including a selectable link, the rejection email message 226 may embed information about the job for which the candidate was rejected including a job identifier, a job title, a company name, or a job location, and so forth.

The recruiting application 220 and the email application 210 may be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system. Alternatively, these components may also be implemented on a general purpose computing system or device as interpreted or executable software code such as a kernel component, an application program, a script, a linked library, an object with methods, and so forth.

The job server 232 may be any type of computer system or computing device such as computer system 100 of FIG. 1. In general, the job server 232 may support services for modeling candidates, companies and jobs, and may support services for matching candidates and jobs by leveraging information about one or more jobs for which a candidate was rejected. In particular, the job server 232 may include a personal recruiter application 234 that may be operably coupled to a candidate modeler 238, a job matching engine 248, a database engine 244 and server storage 274. The personal recruiter application 234 may be implemented as an online application that includes functionality for interacting with the personal recruiting application 206 executing on a computing device, functionality for receiving candidate information from the personal recruiting application 206 and functionality for sending the candidate information to the candidate modeler 238 to generate or update a candidate profile 276. The personal recruiter application 234 may also include functionality for receiving a candidate job list 282 from the job matching engine 248 and functionality to retrieve a candidate job list 282 from server storage 274, functionality to send a candidate job list 282 to the personal recruiting application 206 for display on a computing device such as user client 202.

The job server 232 may also include a company recruiter application 236 that may be operably coupled to a company modeler 240, the database engine 244 and server storage 274. The company recruiter application 236 may include functionality for receiving company information from the company recruiting application 220 and functionality for sending the company information to the company modeler 240 to generate or update a company profile 278. The job server 232 may also include a job modeler 242 that may be operably coupled to the database engine 244 and server storage 274. The job modeler 242 may include functionality for generating or updating a job profile 280 or a rejected job profile 284.

The job server 232 may also include a job matching engine 248 that may be operably coupled to the personal recruiter application 234, a ranking engine 270, the database engine 244 and server storage 274. The job matching engine 248 may include functionality in an embodiment for receiving a request to match a candidate profile to one or more job profiles, functionality for receiving a request to match a job profile to one or more job profiles, functionality for matching a candidate profile to one or more job profiles by leveraging information about one or more jobs for which a candidate was rejected, functionality for matching a job profile to one or more job profiles by leveraging information about one or more jobs for which a candidate was rejected, functionality for sending a list of one of more job profiles to a ranking engine 270 to rank the job profiles, and functionality for returning a reference to a candidate job list 282 in server storage 274 to the personal recruiter application 234. In an embodiment, the job matching engine 248 may include a job similarity search engine 250 having functionality for searching and ranking job profiles that are similar to the job profile for which a candidate was rejected, a candidate2job match engine 252 having functionality for searching and ranking job profiles that match the candidate's profile, a text analyzer 254 having functionality to measure the difference between two texts, a semantic analyzer 256 having functionality to measure the similarity between semantic entities of two texts, a skills analyzer 258 having functionality to measure the similarity between two skills sets, a title analyzer 260 having functionality to measure the difference between two titles, an experience analyzer 262 having functionality to measure the similarity between two sets of text that each describe work experience, an education analyzer 264 having functionality to measure the similarity between two sets of educational levels achieved, a psychometric analyzer 266 having functionality to measure the psychometric assessment of a candidate, and a cognitive analyzer 268 having functionality to measure the cognitive assessment of a candidate.

The job server 232 may also include a ranking engine 270 that may be operably coupled to the job matching engine 248, the database engine 244 and server storage 274. The ranking engine 270 may include functionality in an embodiment for receiving a request to rank a list of matching jobs scored by the job matching engine, functionality to combine rankings of matching jobs, and functionality to generate a short list of ranked jobs for the candidate. In an embodiment, the ranking engine 270 may include a job list generator 272 having functionality to generate the short list of matching jobs.

The job matching engine 248 and each of its components, the ranking engine 270 and each of its components, the database engine 244 and each of its components may each be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system. Alternatively, these components may also be implemented on a general purpose computing system or device as interpreted or executable software code such as a kernel component, an application program, a script, a linked library, an object with methods, and so forth.

The job server 232 may additionally include a database engine 244 and server storage 274. The database engine 244 may provide database services and may include a query processor 246 having functionality to process received queries by retrieving the data from the server storage 274 and processing the retrieved data. The database engine 244, the job matching engine 248, the ranking engine 270, the personal recruiter application 234, the candidate modeler 238, the company recruiter application 236, the company modeler 240, and the job modeler 242 may be operably coupled to server storage 274 that stores information for candidate profiles 276, information for company profiles 278, information for job profiles 280, information for candidate job lists 282, and information for rejected job profiles 284.

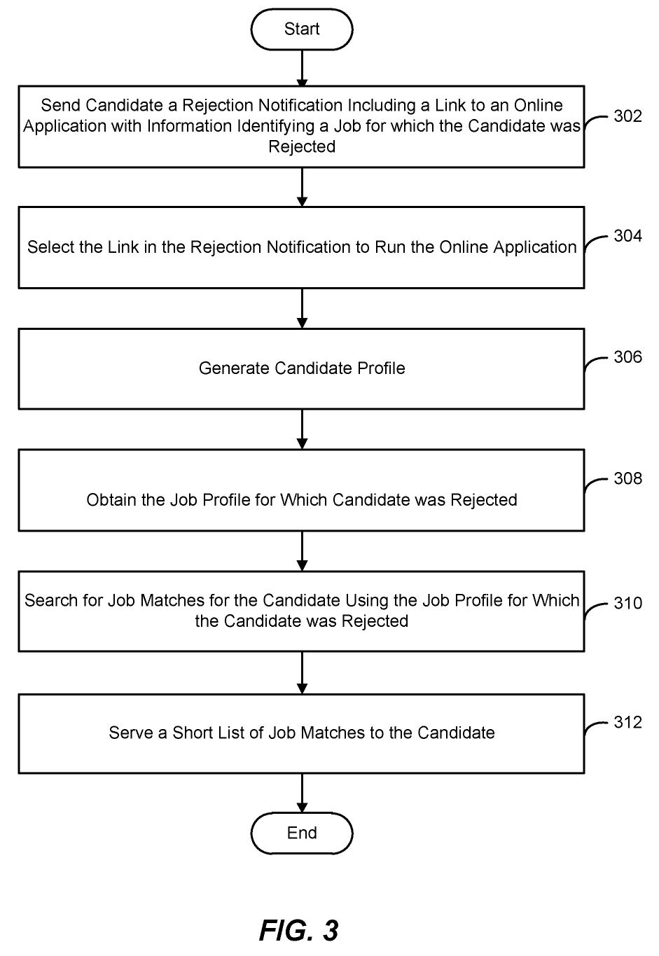

FIG. 3 presents a flowchart generally representing the steps undertaken in one embodiment for searching for job matches for a candidate using the job profile for which the candidate was rejected. At step 302, a rejection notification may be received that includes a link to an online application with information identifying a job for which a candidate was rejected. In an embodiment, an email application executing on a client device such as user client 202 may receive a rejection notification such as email rejection 212 sent from company server 216 to inform a candidate that the candidate's application is rejected for a company job. The rejection notification may include a link such as a Uniform Resource Locator (URL) which may be selected to run an online application and the link may have embedded information identifying the job for which the candidate was rejected. In various embodiments, the link may embed additional information such as the candidate's background and profile. Those skilled in the art will appreciate that such rejection notifications may be sent in various embodiments by various messaging applications like an instant messaging application, a text messaging application such as Simple Message Service (SMS), a chat messaging application, and so forth.

At step 304, the link in the rejection notification may be selected to run an online application. For instance, a link such as job server URL 214 may be selected to run an online application on a server like personal recruiter application 230 on job server 228. The personal recruiter application 234 may receive candidate information from the user client 202 and send the candidate information to the candidate modeler 238 to generate or update a candidate profile 276. At step 306, a candidate profile may be generated. Information collected for a candidate profile may include uploading a resume, specifying skills, specifying desired job and compensation, and taking cognitive, personality, vocational and other assessments such as recorded audio and video interviews. If there is an existing candidate profile, the candidate profile may be updated.

At step 308, a job profile for which a candidate was rejected may be obtained. In an embodiment, when a link such as job server URL 214 may be selected to run an online application on a server like personal recruiter application 230 on job server 228, information embedded in the link identifying a job for which a candidate was rejected may be sent in a request to run the online application from user client 202 to the job server 228. At step 310, a search may be performed for job matches for the candidate using the job profile for which the candidate was rejected. In various embodiments, a search may be made for job matches to the job profile for which the candidate was rejected, and a search may be made for job matches to the candidate profile. The job matches from both of these searches may be combined and ranked. And, at step 312, a short list of job matches may be served to the candidate. In an embodiment the short list may be sent to the user client 202, and the candidate may choose for which jobs to apply. When the candidate may choose to apply for a job at a company, the candidate's profile may be sent to the recruiting application 218 on the company server 216.

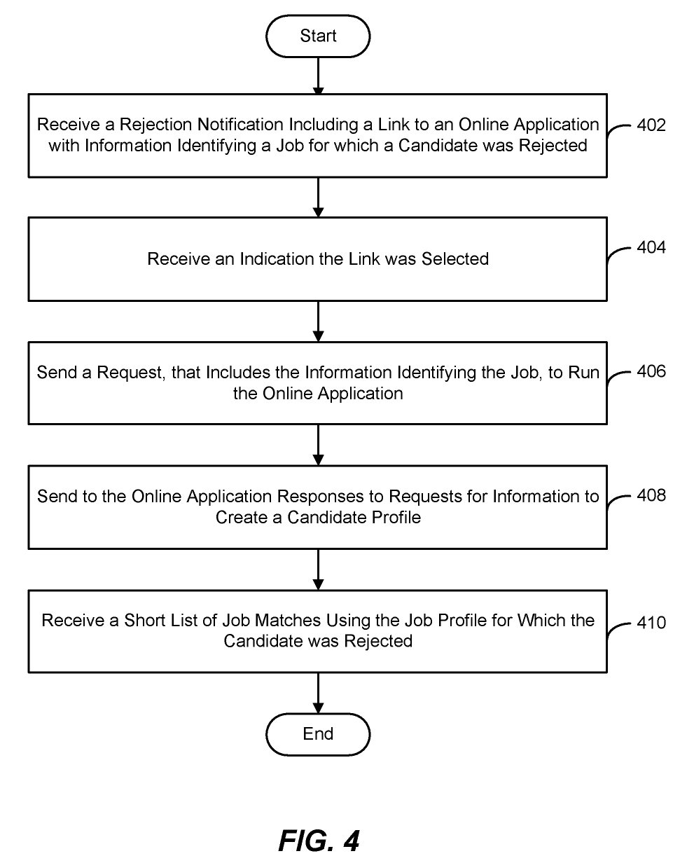

FIG. 4 presents a flowchart generally representing the steps undertaken in one embodiment on a client for searching for job matches for a candidate using the job profile for which the candidate was rejected. At step 402, a rejection notification may be received that includes a link to an online application with information identifying a job for which a candidate was rejected, and an indication may be received that the link in the rejection notification may be selected at step 404. At step 406, a request to run the online application may be sent that includes the information identifying the job for which a candidate was rejected. At step 408, responses to requests for information to create a candidate profile may be sent to the online application. And, at step 410, a short list of job matches using the job profile for which a candidate was rejected may be received.

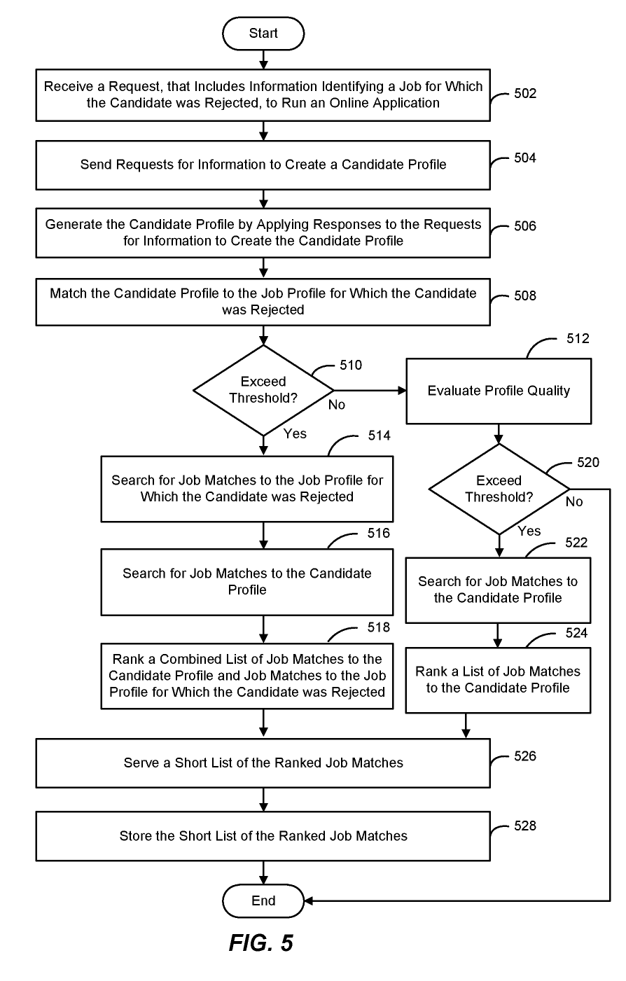

FIG. 5 presents a flowchart generally representing the steps undertaken in an embodiment on a server for searching for job matches for a candidate using the job profile for which the candidate was rejected and the candidate profile. At step 502, a request to run an online application may be received that includes information identifying a job for which a candidate was rejected. At step 504, requests for information to create a candidate profile may be sent, and a candidate profile may be generated at step 506 by applying the responses to the requests for information to create a candidate profile.

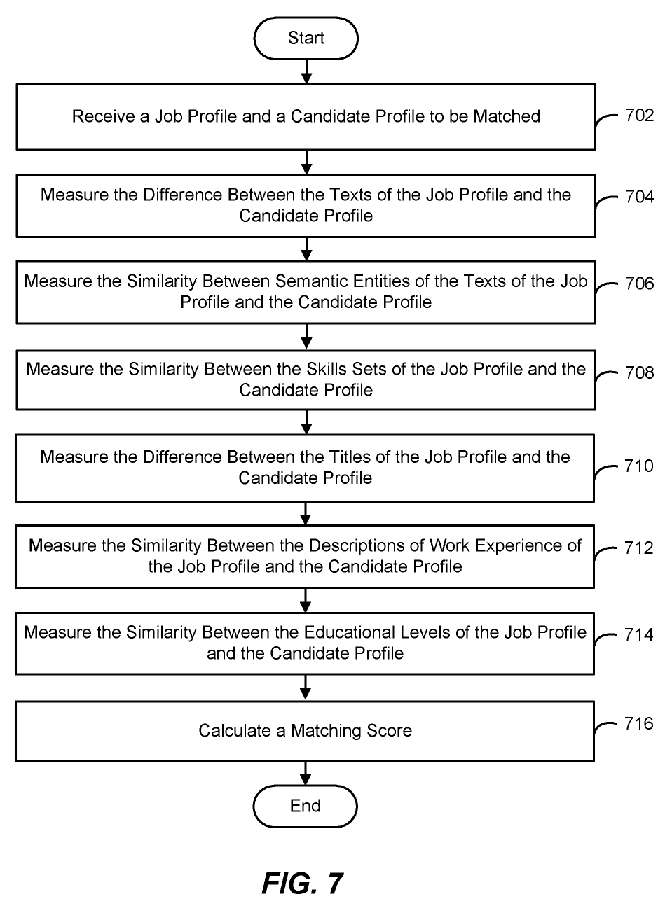

At step 508, the candidate profile may be matched to the job profile for which the candidate was rejected. In an embodiment, the matching between the candidate profile and the job profile for which the candidate was rejected may be based for example on text analysis, semantic analysis, skill set analysis, title analysis, experience analysis, and educational level analysis. Each of these analyses may yield a score in an embodiment that may be normalized, weighted and summed to generate a match score, as described below in further detail in conjunction with FIG. 7. In various embodiments, psychometric analysis and cognitive analysis may be applied as a filter to screen job profiles for psychometric fit and cognitive fit for the candidate. For instance, a job profile may be removed before matching the job profile with the candidate profile if the psychometric score or the cognitive score falls outside a predetermined range. In various other embodiments, the psychometric score and/or the cognitive score may be used in generating the match score by normalizing, weighting and summing the psychometric score and/or the cognitive score with the scores of other analysis used to generate the match score described below in further detail in conjunction with FIG. 7.

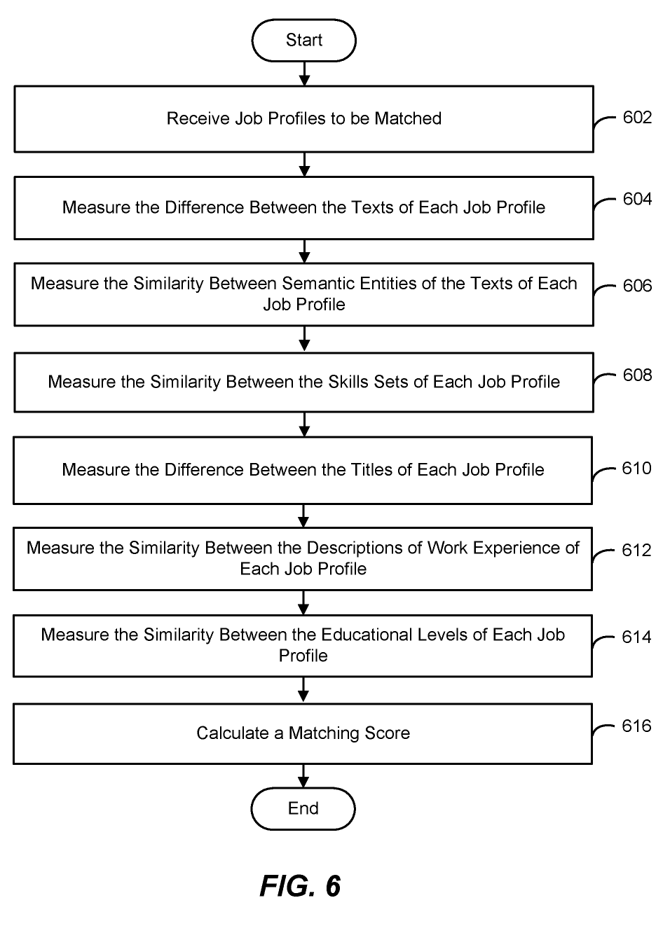

It may be determined at step 510 whether the match score exceeded a threshold. In an embodiment, the threshold value may be set to be a minimum value of correspondence between the candidate profile and the job profile. If the match value exceeds the threshold, then a search may be made at step 514 for job matches to the job profile for which the candidate was rejected. In an embodiment, the matching for job matches to the job profile for which the candidate was rejected may be based for example on text analysis, semantic analysis, skill set analysis, title analysis, experience analysis, and educational level analysis. Each of these analyses may yield a score in an embodiment that may be normalized, weighted and summed to generate a match score, as described below in further detail in conjunction with FIG. 6.

At step 516, a search may be made for job matches to the candidate profile. In an embodiment, the matching for job matches to the candidate profile may be based for example on text analysis, semantic analysis, skill set analysis, title analysis, experience analysis, and educational level analysis. Each of these analyses may yield a score in an embodiment that may be normalized, weighted and summed to generate a match score, as described below in further detail in conjunction with FIG. 7.

At step 518, a combined list of job matches to the candidate profile and job matches to the job profile for which the candidate was rejected may be ranked. In an embodiment, the list of job matches made to the candidate profile at step 516 and the list of job matches made to the job profile for which the candidate was rejected at step 514 may be combined and the job matches ranked by their respective match scores. In an embodiment, match scores from each list for the same job may be averaged, and the combined list may be ranked. In an alternate embodiment, the rankings from the lists may be combined directly through a voting-related method known to those skilled in the art, such as the Borda count method or the Condorcet method.

At step 526, a short list of ranked job matches may be served to a user client, and the short list of ranked job matches may be stored in persistent storage. In an embodiment, the short list of ranked job matches may be generated from the combined list of job matches by filtering the list using a minimum matching score threshold or by limiting the short list to a sublist of a fixed number of job matches with the highest scores.

Returning to step 512 above, if the match value between the candidate profile and the job profile for which the candidate was rejected does not exceed the threshold, then the candidate profile quality may be evaluated at step 512. In an embodiment, the candidate profile quality may be determined by assigning a normalized value between 0 and 1 to individual attributes of a candidate's resume including work experience, corporate employers, education level, schools attended, assessment scores, interview scores, and so forth. For example, a normalized value may be assigned to work experience by averaging the normalized value of the number of months employed and the normalized value of the number of different corporate employers. In an embodiment, a normalized value for the number of months employed may be assigned by dividing the number of months employed by a maximum expected value such as 12 months, then capping the result at 1. A normalized value for the number of different corporate employers may be assigned by dividing the number of different corporate employers by a maximum expected value such as 10, then capping the result at 1. A normalized value may be assigned to corporate employers as the maximum value assigned to each corporate employer in the candidate profile from a scored list of companies. A normalized value may be assigned to education level based upon highest achieved educational level, ranging from 0.5 for completion of high school to 1.0 for completion of a doctorate degree. A normalized value may be assigned to schools attended as the maximum value assigned to each school attended in the candidate profile from a scored list of schools. A normalized value may be assigned to assessment scores by averaging the normalized value of the measured variables or by taking the maximum of normalized values of a selected set of measured variables. A normalized value may be assigned to interview scores by extracting individual attributes from the text of the interview and assigning a normalized score to each extracted attribute. For example, individual attributes extracted may include the word difficulty scores, the number of work-related semantic entities, sentiment words, overall sentiment in the text, and so forth.

The normalized values assigned to individual attributes of the candidate resume may be weighted and summed to generate a candidate profile quality score as follows:

score=β1*score_work_experience+β2*score_corporate_employers+ . . . +βN*score_N.

At step 520, it may be determined whether the candidate profile quality score exceeds a threshold. If not, then processing may end for searching for job matches for a candidate using the job profile for which the candidate was rejected. In an embodiment, an empty list of jobs may be served to a user client. Otherwise, if it is determined that the candidate profile quality score exceed a threshold at step 520, a search may be made for job matches to the candidate profile at step 522. In an embodiment, the matching for jobs to the candidate profile may be based for example on text analysis, semantic analysis, skill set analysis, title analysis, experience analysis, and educational level analysis. Each of these analyses may yield a score in an embodiment that may be normalized, weighted and summed to generate a match score, as described below in further detail in conjunction with FIG. 7. The job matches may be ranked at step 524 and a short list of ranked job matches may be served to a user client at step 526.

FIG. 6 presents a flowchart generally representing the steps undertaken in an embodiment for matching a job profile to a job profile. At step 602, job profiles to be matched may be received. In an embodiment, the job matching engine 248 may send queries to the database engine 244 to retrieve job profiles 280 from the server storage 274. The job matching engine 248 may invoke the job similarity search engine 250 to match a job profile such as rejected job profile 284 to a job profile 280. At step 604, a difference between the texts of each job profile may be measured. For instance, the text analyzer 254 may measure the Levenshtein distance between the texts of the job descriptions of each job profile in an embodiment. At step 606, the similarity between semantic entities of the texts of each job profile may be measured. In an embodiment, the semantic analyzer 256 may calculate the Jaccard similarity between the set of semantic entities extracted from the job descriptions of each job profile.

At step 608, the similarity between the skills sets of each job profile may be measured. For example, the skills analyzer 258 may calculate the Jaccard similarity between the skills set extracted from the job descriptions of each job profile in an embodiment. At step 610, the difference between the titles of each job profile may be measured. In an embodiment, the title analyzer 260 may measure the Levenshtein distance between the texts of the job titles of each job profile. At step 612, the similarity between the descriptions of work experience of each job profile may be measured. The experience analyzer 262 may calculate the Jaccard similarity between the experience tags or words extracted from the job descriptions of each job profile in an embodiment.

At step 614, the similarity between the educational levels of each job profile may be measured. The education analyzer 264 may compare educational levels extracted from the job descriptions of each job profile. At step 616, a matching score may be calculated. Each of these analyses may yield a score in an embodiment that may be normalized, weighted and summed to generate a match score as follows:

score=α1*score_text+α2*score_semantic+α3*score_skills+α4*score_title+α5*score_experience+α6*score_education.

FIG. 7 presents a flowchart generally representing the steps undertaken in an embodiment for matching a candidate profile to a job profile. At step 702, a candidate profile and a job profile to be matched may be received. In an embodiment, the job matching engine 248 may send queries to the database engine 244 to retrieve the candidate profile 276 and the job profile 280 from the server storage 274. The job matching engine 248 may invoke the candidate2job match engine 252 to match the candidate profile 276 to the job profile 280. At step 704, a difference between the texts of the candidate profile and the job profile may be measured. For instance, the text analyzer 254 may measure the Levenshtein distance between the texts of the job descriptions of the candidate profile and the job profile in an embodiment. At step 706, the similarity between semantic entities of the texts of the candidate profile and the job profile may be measured. In an embodiment, the semantic analyzer 256 may calculate the Jaccard similarity between the set of semantic entities extracted from the job descriptions of the candidate profile and the job profile.

At step 708, the similarity between the skills sets of the candidate profile and the job profile may be measured. For example, the skills analyzer 258 may calculate the Jaccard similarity between the skills set extracted from the job descriptions of the candidate profile and the job profile in an embodiment. At step 710, the difference between the titles of the candidate profile and the job profile may be measured. In an embodiment, the title analyzer 260 may measure the Levenshtein distance between the texts of the job titles of the candidate profile and the job profile. At step 712, the similarity between the descriptions of work experience of the candidate profile and the job profile may be measured. The experience analyzer 262 may calculate the Jaccard similarity between the experience tags or words extracted from the job descriptions of the candidate profile and the job profile in an embodiment.

At step 714, the similarity between the educational levels of the candidate profile and the job profile may be measured. The education analyzer 264 may compare educational levels extracted from the job descriptions of the candidate profile and the job profile. At step 716, a matching score may be calculated. Each of these analyses may yield a score in an embodiment that may be normalized, weighted and summed to generate a match score as follows:

score=μ1*score_text+μ2*score_semantic+μ3*score_skills+μ4*score_title+μ5*score_experience+μ6*score_education.

Thus job matches may be performed in an embodiment to a candidate profile and to a job profile which may be combined and ranked to generate a short list of jobs aligned to the candidate's employments interests and capabilities.

Beneficially, the user client may send a request through a network to an online recruiting application on a company server to apply for a job on the short list of jobs matched. And the candidate profile may be uploaded into the online recruiting application on a company server as part of the application submission process. Thus the system and method allow a candidate to easily apply for several jobs on the short list of jobs matched.

As can be seen from the foregoing detailed description, a system and method generally directed to sourcing and matching candidates to jobs is provided. More particularly, the system and method disclosed may receive a rejection notification that includes a link to an online application with information identifying a job for which a candidate was rejected and may match candidates and jobs by leveraging the information about the job for which a candidate was rejected. Furthermore, the system and method may support convenient submission of a candidate's application to relevant jobs they want in a suitable company. Importantly, the system and method may more accurately surface job matches that fit the candidate's employment interests in the type of job and type of company desired. As a result, the system and method provide significant advantages and benefits needed in contemporary computing and in online recruiting applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for job matching, comprising:
a processor;
a job matching engine operably coupled to the processor that matches a candidate profile of a candidate to a plurality of job profiles and matches a job profile of a job for which the candidate was rejected to another plurality of job profiles;
a ranking engine operably coupled to the job matching engine that ranks a combined list of the plurality of job matches to the candidate profile of the candidate and the another plurality of job matches to the job profile of the job for which the candidate was rejected;
a job list generator operably coupled to the ranking engine that generates a short list of a plurality of ranked job matches comprising a sublist of the highest ranked job matches from the combined list of the plurality of job matches to the candidate profile of the candidate and the another plurality of job matches to the job profile of the job for which the candidate was rejected; and
a server storage operably coupled to the job list generator that stores the short list of the plurality of ranked job matches.

2. The system of claim 1 further comprising a job similarity search engine operably coupled to the job matching engine that searches for the another plurality of job profiles similar to the job profile of the job for which the candidate was rejected.

3. The system of claim 1 further comprising a text analyzer operably coupled to the job matching engine that calculates a normalized value derived from measuring a difference between a text of a job profile of the another plurality of job profiles and another text of the job profile of the job for which the candidate was rejected.

4. The system of claim 1 further comprising a semantic analyzer operably coupled to the job matching engine that calculates a normalized value derived from measuring a similarity between a set of semantic entities extracted from a job description of a job profile of the another plurality of job profiles and another set of semantic entities extracted from a job description of the job profile of the job for which the candidate was rejected.

5. The system of claim 1 further comprising a title analyzer operably coupled to the job matching engine that calculates a normalized value derived from measuring a difference between a text of a job title of a job profile of the another plurality of job profiles and another text of a job title of the job profile of the job for which the candidate was rejected.

6. The system of claim 5 further comprising an experience analyzer operably coupled to the job matching engine that calculates a normalized value derived from measuring a similarity between a set of experience tags extracted from a job description of a job profile of the another plurality of job profiles and another set of experience tags extracted from a job description of the job profile of the job for which the candidate was rejected.

7. The system of claim 6 further comprising an educational analyzer operably coupled to the job matching engine that calculates a normalized value derived from measuring a similarity between a set of educational levels extracted from a job description of a job profile of the another plurality of job profiles and another set of educational levels extracted from a job description of the job profile of the job for which the candidate was rejected.

8. The system of claim 1 further comprising a skills analyzer operably coupled to the job matching engine that calculates a normalized value derived from measuring a similarity between a set of skills extracted from a job description of a job profile of the another plurality of job profiles and another set of skills extracted from a job description of the job profile of the job for which the candidate was rejected.

9. A computer system for sourcing a candidate for employment, comprising:
a processor;
a messaging application operably coupled to the processor that receives a notification having a link to an online application, the link including information identifying a job for which a candidate was rejected;
a personal recruiting application operably coupled to the messaging application that sends a request to run the online application, the request including the information identifying the job for which the candidate was rejected, and that receives a short list of a plurality of jobs matched using a job profile of the job for which the candidate; and
a user storage operably coupled to the personal recruiting application that stores the short list of the plurality of jobs matched using the job profile of the job for which the candidate was rejected.

10. The system of claim 9 further comprising a company recruiting application operably coupled to the personal recruiting application that sends a request to an online recruiting application to apply to at least one of the plurality of jobs matched using the job profile of the job for which the candidate was rejected.

11. A computer-implemented method performed by a processor for sourcing a candidate for employment, comprising:
receiving on a computing device a notification having a link to an online application that includes information identifying a job for which a candidate was rejected;
receiving an indication that the link was selected;
sending a request that includes the information identifying the job for which the candidate was rejected to run the online application; and
receiving a short list of a plurality of jobs matched using a job profile of the job for which the candidate was rejected for display on a computing device.

12. The method of claim 11 further comprising sending to the online application a plurality of responses to a plurality of requests for information to generate a candidate profile.

13. The method of claim 11 further comprising sending a request to an online recruiting application to apply to at least one of the plurality of jobs matched using the job profile of the job for which the candidate was rejected.

14. A computer-implemented method performed by a processor for job matching, comprising:
receiving a request that includes information identifying a job for which a candidate was rejected to run an online application;
searching for a plurality of job matches to the job profile of the job for which the candidate was rejected;
searching for another plurality of job matches to a candidate profile of the candidate;
ranking a combined list of the plurality of job matches to the job profile of the job for which the candidate was rejected and the another plurality of job matches to the candidate profile of the candidate;
storing a short list of ranked job matches comprising a sublist of the highest ranked job matches from the combined list of the plurality of job matches to the job profile of the job for which the candidate was rejected and the another plurality of job matches to the candidate profile of the candidate; and
serving the short list of ranked job matches for display on a computing device.

15. The method of claim 14 further comprising:
sending a plurality of requests for information to generate the candidate profile; and
generating the candidate profile from a plurality of responses to the plurality of requests for information.

16. The method of claim 14 further comprising matching the candidate profile to the job profile of the job for which the candidate was rejected.

17. The method of claim 14 wherein the searching for the plurality of job matches to the job profile of the job for which the candidate was rejected further comprises calculating a normalized value derived from measuring a difference between a text of a job and another text of the job profile of the job for which the candidate was rejected.

18. The method of claim 14 wherein the searching for the another plurality of job matches to the candidate profile of the candidate further comprises calculating a normalized value derived from measuring a difference between a text of a job and another text of the candidate profile of the candidate.

19. A computer system for providing offers, comprising:
means for receiving a request that includes information identifying a job for which a candidate was rejected to run an online application;
means for generating a candidate profile for the candidate;
means for searching for a plurality of job matches to a job profile of the job for which the candidate was rejected;
means for searching for another plurality of job matches to the candidate profile of the candidate; and
means for outputting a short list of ranked job matches from the plurality of job matches to the job profile of the job for which the candidate was rejected and from the another plurality of job matches to the candidate profile of the candidate.

20. A computer-readable storage medium having computer-executable instructions for performing the method comprising:
receiving a request that includes information identifying a job for which a candidate was rejected to run an online application;
searching for a plurality of job matches to the job profile of the job for which the candidate was rejected;
searching for another plurality of job matches to a candidate profile of the candidate;
ranking a combined list of the plurality of job matches to the job profile of the job for which the candidate was rejected and the another plurality of job matches to the candidate profile of the candidate;
storing a short list of ranked job matches comprising a sublist of the highest ranked job matches from the combined list of the plurality of job matches to the job profile of the job for which the candidate was rejected and the another plurality of job matches to the candidate profile of the candidate; and
serving the short list of ranked job matches for display on a computing device.
